(19) United States
(12) Patent Application Publication
(10) Pub. No.: US 2015/0274303 A1
(43) Pub. Date: Oct. 1, 2015

(54) Structure and Method for Reducing Air Flow in a Wall Volume of an Aircraft

(71) Applicant: The Boeing Company, Chicago, IL (US)

(72) Inventors: John C. Gray, Shoreline, WA (US); Warren A. Atkey, Bothell, WA (US)

(73) Assignee: The Boeing Company, Chicago, IL (US)

(21) Appl. No.: 14/230,348

(22) Filed: Mar. 31, 2014

(51) Int. Cl. B64D 13/02; B64D 45/00; B64D 11/04; B64C 1/00; B64D 11/00

(52) U.S. Cl. CPC B64D 13/02; B64C 1/00; B64D 11/00; B64D 11/04; B64D 45/00

(57) ABSTRACT

An aircraft including a fuselage defining an upper lobe and a lower lobe, the fuselage including a wall structure that includes an outboard boundary and an inboard boundary spaced from the outboard boundary, wherein the outboard boundary and the inboard boundary define a wall volume therebetween, and at least one sealing member positioned in the wall volume.

### FIELD

This application relates to aircraft and, more particularly, to air flow within the wall volume of an aircraft.

### BACKGROUND

Modern fixed wing commercial transport aircraft share features in common with their predecessors, including wings, a fuselage, control surfaces and engines. Continuous advancement in aerodynamics, materials, engine power and efficiency, and component design contribute to faster, safer air travel. However, the generally cylindrical fuselage has remained a fairly consistent and recognizable feature of commercial aircraft.

An aircraft fuselage is typically divided into separate volumes. In many instances, passengers sit in a volume referred to as the passenger cabin. The passenger cabin is often separated from volumes below in which cargo is carried, in which airplane mechanical and electrical systems are located, and through which air flows. The cargo volumes may be axially separated by the wing box and main landing gear bay into the forward and aft cargo compartments. The combination of the passenger cabin and crown volumes is commonly referred to as the upper lobe, while the combination of the cargo compartments, bilge, left and right cheeks, and floor beam volumes is commonly referred to as the lower lobe.

Conditioned air is provided to the passenger volume to pressurize the airplane fuselage and control temperature, contaminants and odors. The majority of the air (air not transported directly to the lower lobe by the air moving system) must flow from the upper lobe to the lower lobe of the fuselage where it can either be recirculated back to the passenger cabin or be released to the ambient atmosphere from which it was originally drawn. Transport of air flow from the upper to lower lobes is intended to occur through return air grilles located near the interface of the floor and passenger cabin sidewalls. “Sidewall air flow” or “SWF” is a term used to describe unintended air flow from an aircraft upper lobe to lower lobe via unintended paths. These unintended air flow paths include, but are not limited to, the sidewall cavity between the airplane skin and the passenger cabin sidewall liner panel and the volume between the aft pressure bulkhead and the aft cabin galley endwall. This air leakage may impact performance of aircraft systems, including impacting the passenger cabin Return Air Grille (RAG) air velocity, which affects the smoke penetration performance during a cargo fire event, the thermal performance of the Cabin Air Conditioning and Temperature Control System (CACTCS), the ability of the ECS subsystem to prevent smoke and odor migration, such as that discharged by the Lavatory and Galley Ventilation (LGV) subsystem below the cabin floor, into the passenger cabin, the pressure differential and resultant air flow direction between the Flight Deck (FD) and passenger cabin, and the efficiency with which the Air Distribution (AD) subsystem ventilates the passenger cabin.

It has been supposed that the various components housed in the space within the fuselage wall structure, i.e. the “wall volume,” that are often packed quite tightly, sufficiently obstructed air flow within the wall volume. However, despite the presence of tightly packed wall volume components within the wall volume, undesired air flow within the wall volume occurs.

Accordingly, there remains a need for reducing air leakage beyond intended air flow paths in an aircraft.

### SUMMARY

In one embodiment, the disclosed aircraft may include a fuselage defining an upper lobe and a lower lobe, the fuselage including a wall structure that includes an outboard boundary and an inboard boundary spaced from the outboard boundary, wherein the outboard boundary and the inboard boundary define a wall volume therebetween, and at least one sealing member positioned in the wall volume

In another embodiment, the disclosed method for reducing air flow in an aircraft may include providing at least one sealing member in a wall volume between an outboard boundary and an inboard boundary of a wall structure that extends along a longitudinal axis of the aircraft, the sealing member positioned in the wall volume such that the sealing member axially extends through the wall volume at a substantially constant waterline.

Other embodiments of the disclosed structure and method for reducing air flow in a wall volume of an aircraft will become apparent from the following detailed description, the accompanying drawings and the appended claims.

### BRIEF DESCRIPTION OF THE DRAWINGS

FIG. 1 is a schematic side elevational view of an aircraft in accordance with a first embodiment of the present disclosure;

FIG. 2 is an axial cross-sectional view of a fuselage of the aircraft of FIG. 1 taken coincident with a cargo compartment;

FIG. 3 is a detailed view of a portion of the fuselage of FIG. 2, showing a sealing member positioned in the wall volume defined by the wall structure of the fuselage;

FIG. 4 is an axial cross-sectional view of a portion of a fuselage of an aircraft provided with a sealing member in accordance with one variation of the first embodiment;

FIG. 5 is an axial cross-sectional view of a portion of a fuselage of an aircraft provided with a sealing member in accordance with another variation of the first embodiment;

FIG. 6 is a detailed view of a portion of a fuselage of an aircraft, showing multiple sealing members positioned in the wall volume defined by the wall structure of the fuselage in accordance with another embodiment of the present disclosure;

FIG. 7 is a flow chart depicting one embodiment of the disclosed method for reducing air flow in a wall volume;

FIG. 8 is a flow diagram of an aircraft production and service methodology; and

FIG. 9 is a block diagram of an aircraft.

### DETAILED DESCRIPTION

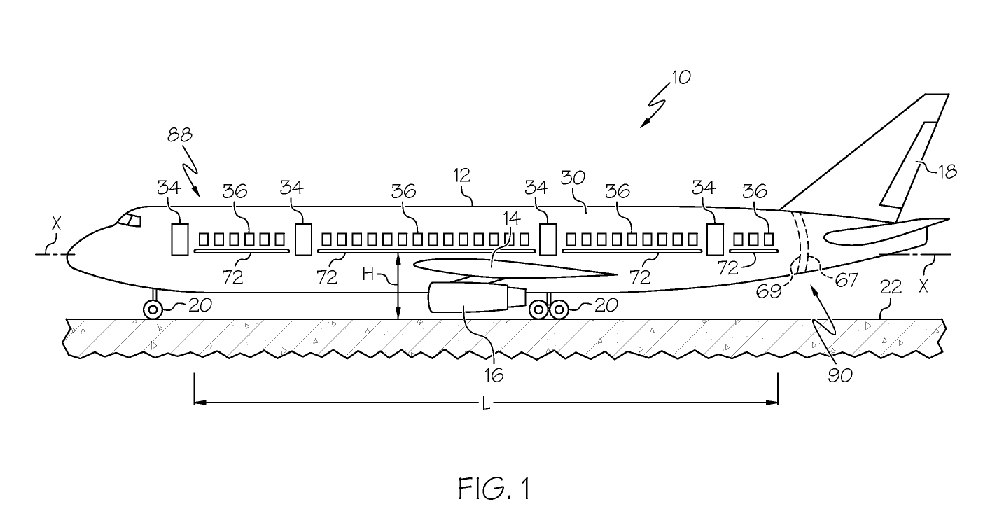

Referring to FIG. 1, the disclosed aircraft, generally designated 10, may include a fuselage 12, wings 14, engines 16 and control surfaces 18. Wheels 20 (or other motion facilitating devices) may facilitate takeoff and landing of the aircraft 10, as well as taxiing along the tarmac 22. Of course, the aircraft 10 may include various additional components and systems, such as an environmental system, navigational systems, electrical systems and hydraulic systems, as are known in the art.

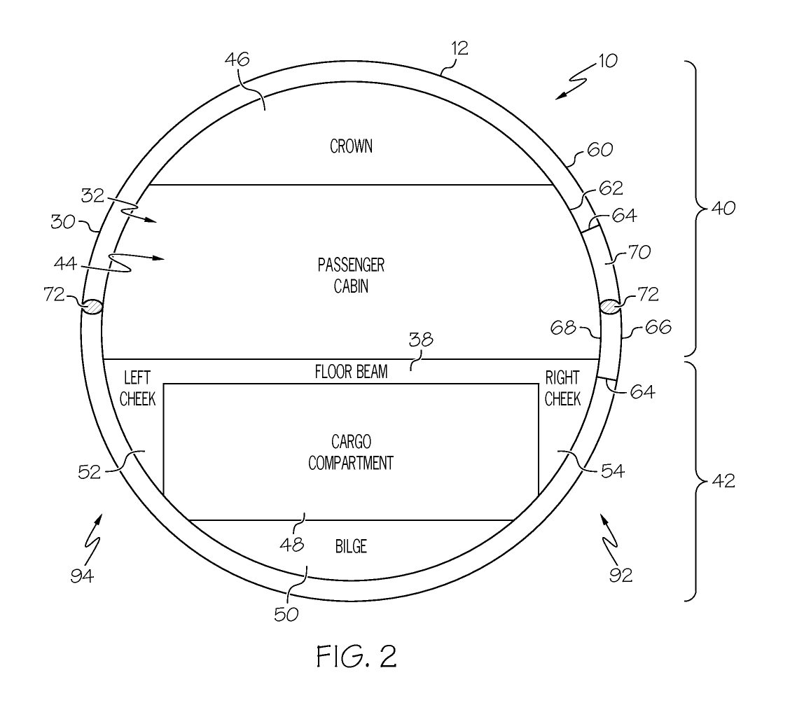

The fuselage 12 may extend along a longitudinal axis X of the aircraft 10. As shown in FIG. 2, the fuselage 12 may include a wall structure 30 having an outboard boundary 60 that defines a fuselage volume 32 (the entire volume within the outboard boundary 60). One or more doors 34 (FIG. 1) may optionally be formed in the wall structure 30 of the fuselage 12 to provide access to the fuselage volume 32. Windows 36 (FIG. 1) may also be included to provide a view through the wall structure 30 of the fuselage 12.

Referring to FIG. 2, a floor beam 38 may divide the fuselage volume 32 into an upper lobe 40 and a lower lobe 42. The upper lobe 40 may include a passenger cabin 44 and, optionally, one or more additional compartments, such as a crown 46. The lower lobe 42 may include a cargo compartment 48 and, optionally, one or more additional compartments, such as a bilge 50, a left cheek 52 and a right cheek 54.

The wall structure 30 of the fuselage 12 may include an outboard boundary 60, an inboard boundary 62 and, optionally, structural members 64. The structural members 64 may form the frame of the fuselage 12.

In one construction, the outboard boundary 60 of the wall structure 30 may be the skin 66 of the fuselage 12. Therefore, the passenger cabin sidewall 68 may form at least a portion of the inboard boundary 62 of the wall structure 30.

In another construction, the outboard boundary 60 of the wall structure 30 may be the aft pressure bulkhead 67 (FIG. 1) of the fuselage 12. Therefore, the passenger cabin sidewall 68 and/or the aft cabin galley endwall 69 may form at least a portion of the inboard boundary 62 of the wall structure 30.

The inboard boundary 62 of the wall structure 30 of the fuselage 12 may be inwardly spaced from the outboard boundary 60 to define a wall volume 70 therebetween. An uncontrolled air flow between the upper lobe 40 and the lower lobe 42 typically exists within the wall volume 70 of conventional aircraft. However, a sealing member 72 may be positioned within the wall volume 70 to substantially inhibit, if not fully eliminate, undesired air flow within the wall volume 70 of the disclosed aircraft 10.

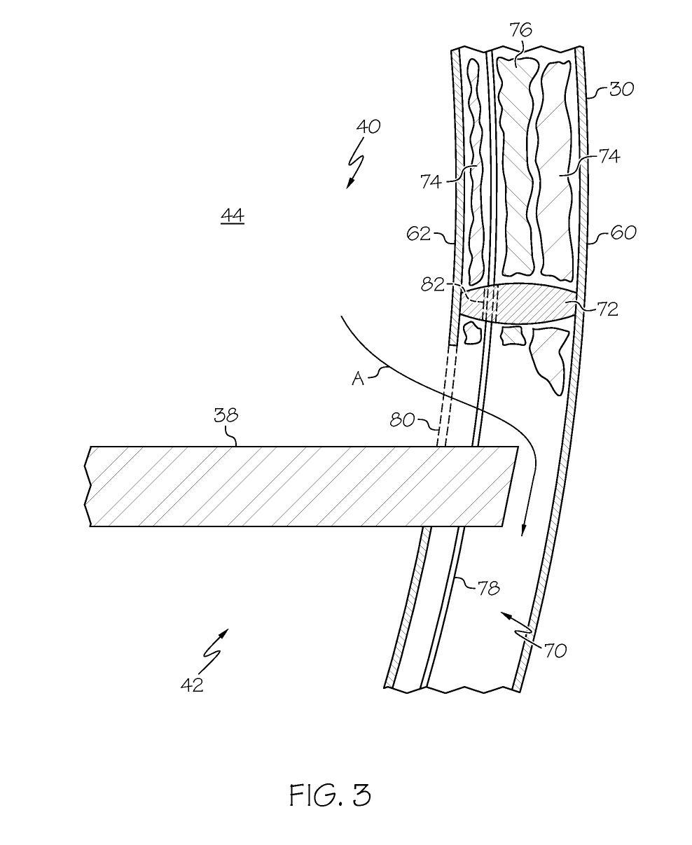

Referring to FIG. 3, the wall volume 70 of the wall structure 30 of the fuselage 12 may house various wall volume components, such as insulation 74 (e.g., insulation blankets), fire barriers 76 and transport elements 78 (e.g., ducts, pipes, hoses, tubes, wires, harnesses etc.). By incorporating sealing members 72 into the wall structure 30 of the fuselage 12, unintended and undesired air flow within the wall volume 70 may be significantly reduced (if not eliminated), thereby promoting desired air flow.

As an example, desired air flow may be air flow from the passenger cabin 44 of the upper lobe 40, through the return air grille 80 into the wall volume 70, and then down to the lower lobe 42 by way of the wall volume 70, as shown by arrow A. To effect the desired air flow, the return air grille 80 may be located proximate the transition from the upper lobe to the lower lobe, such as just above the floor beam 38, and the sealing member 72 may be positioned proximate (e.g., just above) the return air grille 80.

In a first embodiment, the sealing member 72 may be positioned in the wall volume 70 and may extend from proximate (at or near) the outboard boundary 60 to proximate (at or near) the inboard boundary 62 of the wall structure 30. The sealing member 72 may extend from the outboard boundary 60 to the inboard boundary 62 such that no gap (or substantially no gap) is provided therebetween. For example, the sealing member 72 may be compressed between the outboard boundary 60 and the inboard boundary 62.

The sealing member 72 may be attached to the outboard boundary 60, to the inboard boundary 62 or both the outboard boundary 60 and the inboard boundary 62 of the wall structure 30. The attachment between the sealing member 72 and the inboard and/or outboard boundaries 60, 62 may be effected with an adhesive, mechanical fasteners or the like. Alternatively, there may be no physical attachment between the sealing member 72 and the inboard and/or outboard boundaries 60, 62. Rather, the sealing member 72 may be held in place by compression forces applied to the sealing member 72 by the inboard and outboard boundaries 60, 62 of the wall structure 30.

The sealing member 72 may be formed from various materials. In one particular realization, the sealing members 72 may be formed from a flexible yet resilient material to accommodate relative movement of the inboard and outboard boundaries 60, 62, such as when the aircraft experiences pressure swings, while still maintaining a substantially airtight seal. As one general example, the sealing member 72 may be formed from or may include an elastomeric material. As one specific example, the sealing member 72 may be formed from or may include rubber, such as natural or synthetic rubber.

Optionally, to reduce overall weight of the aircraft 10 (FIG. 1) and, thus, improve overall fuel economy of the aircraft 10, the sealing member 72 may be formed from or may include a foam material. For example, the sealing member 72 may be formed from or may include foam rubber.

As shown in FIG. 3, the sealing member 72 may be formed as a solid body. However, one or more through-channels 82 may optionally be formed in the sealing member 72. For example, the through-channels 82 may allow continuous passage of transport elements 78, such as ducts, conduits, wires, hoses, pipes, tubes and the like, notwithstanding the presence of the sealing member 72.

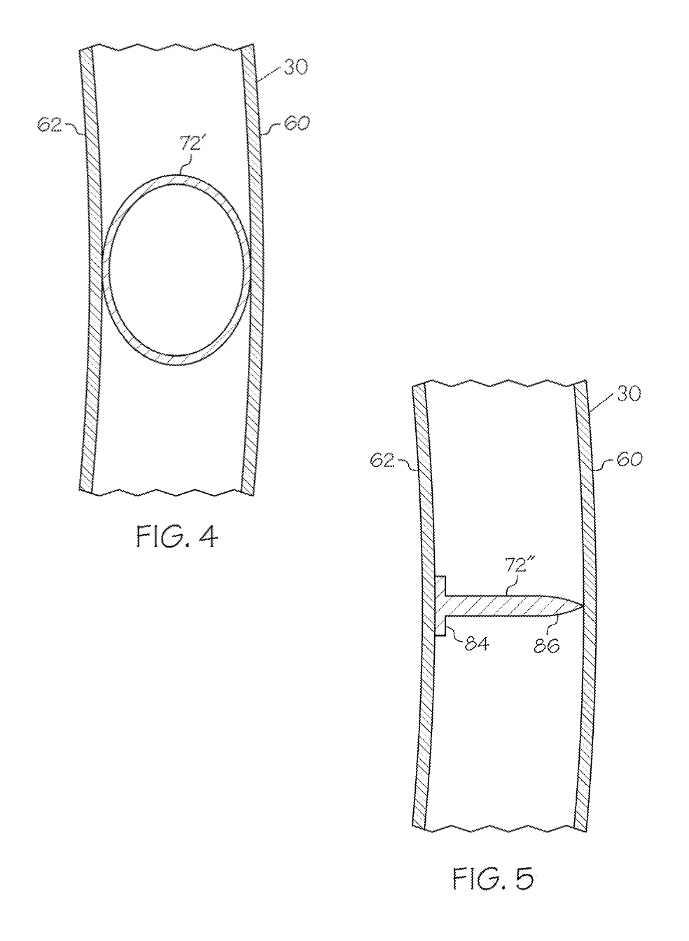

Referring to FIG. 4, in one variation, the sealing member 72′ may be formed as a hollow body. For example, the sealing member 72′ may be formed from or may include a bulb seal. The bulb seal sealing member 72′ may be connected to the outboard boundary 60, to the inboard boundary 62 or to both the outboard and inboard boundaries 60, 62 of the wall structure 30.

Referring to FIG. 5, in another variation, the sealing member 72″ may be formed as a blade seal. The sealing member 72″ may include a proximal end 84 attached to the inboard boundary 62 (or the outboard boundary 60) of the wall structure 30 and a distal end 86 that extends to (e.g., into touching engagement), but is not attached to, the outboard boundary 60 (or the inboard boundary 62) of the wall structure 30.

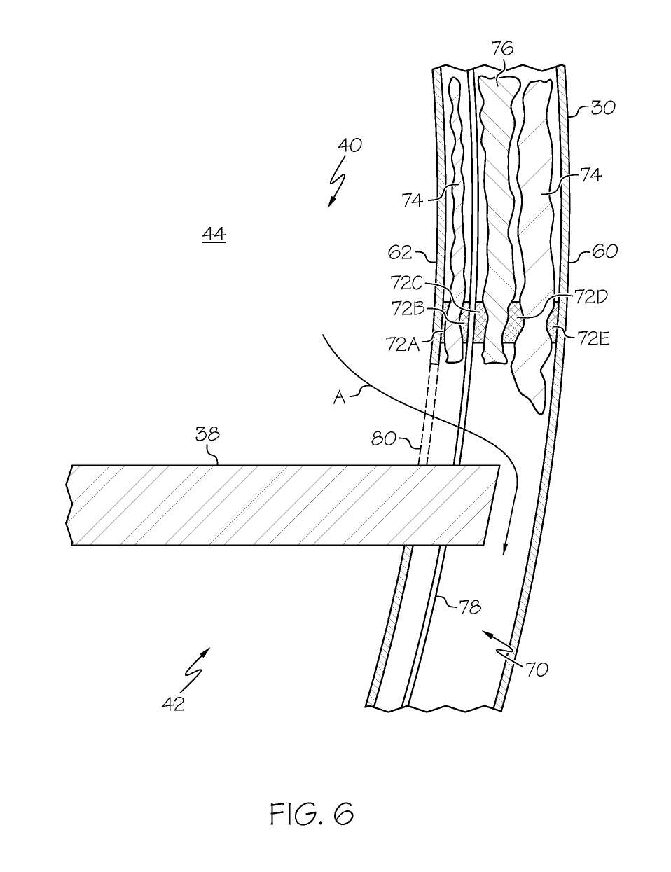

Another embodiment of the present disclosure is illustrated in FIG. 6 and may utilize the wall volume components 74, 76, 78 that may be housed within the wall volume 70 of the wall structure 30. Specifically, rather than a single, continuous sealing member 72 (FIG. 3) extending from proximate the outboard boundary 60 to proximate the inboard boundary 62 of the wall structure 30, one or more sealing members 72A, 72B, 72C, 72D, 72E may be positioned in one or more gaps within the wall volume 70 of the wall structure 30 to inhibit (if not eliminate) unintended and undesired passage of air. For example, sealing member 72A may be positioned between the inboard boundary 62 and insulation 74; sealing member 72B may be positioned between insulation 74 and transport element 78; sealing member 72C may be positioned between transport element 78 and fire barrier 76; sealing member 72D may be positioned between fire barrier 76 and insulation 74; and sealing member 72E may be positioned between insulation 74 and outboard boundary 60.

Thus, the quantity of sealing members 72A, 72B, 72C, 72D, 72E used at a particular location (e.g., longitudinal position and height H (FIG. 1)), as well as the size and shape of the sealing members 72A, 72B, 72C, 72D, 72E, may be dictated by, among other possible factors, the composition of the wall structure 30 at that location and the quantity/size/shape required to achieve a suitable seal at that location.

Referring back to FIG. 1, which shows sealing member 72, but is also applicable to sealing member 72′ (FIG. 4), sealing member 72″ (FIG. 5), and sealing members 72A, 72B, 72C, 72D, 72E (FIG. 6), sealing member 72 may axially extend through the wall volume 70 along at least a portion of the longitudinal length L of the fuselage 12. The sealing member 72 may axially extend continuously along at least a portion of the longitudinal length L of the fuselage 12 or, as shown in FIG. 1, may axially extend as a plurality of segments, such as segments that terminate when the sealing member 72 is interrupted by a door 34.

The sealing member 72 may extend from proximate the forward end 88 of the fuselage 12 to proximate the aft end 90 of the fuselage 12. The sealing member 72 may have a sealing member total longitudinal length, which may be the total continuous longitudinal length of the sealing member 72 or the sum of all sealing member 72 segment lengths. In one embodiment, the sealing member total longitudinal length may be at least about 20 percent of the longitudinal length L of the fuselage 12. In another embodiment, the sealing member total longitudinal length may be at least about 50 percent of the longitudinal length L of the fuselage 12. In another embodiment, the sealing member total longitudinal length may be at least about 75 percent of the longitudinal length L of the fuselage 12. In yet another embodiment, the sealing member total longitudinal length may be at least about 90 percent of the longitudinal length L of the fuselage 12.

Referring to FIG. 2, which shows sealing members 72, but is also applicable to sealing member 72′ (FIG. 4), sealing member 72″ (FIG. 5), and sealing members 72A, 72B, 72C, 72D, 72E (FIG. 6), the sealing member 72 on the starboard side 92 of the aircraft 10 may be configured in a similar manner as the sealing member 72 on the port side 94 of the aircraft 10. However, configuring one side 92, 94 differently than the other side 92, 94 is also contemplated and will not result in a departure from the scope of the present disclosure. Furthermore, while only two sealing members 72 (starboard side 92 and port side 94) are shown in FIG. 2, those skilled in the art will appreciate that fewer than two or more than two sealing members 72 may be used, and such a modification will not result in a departure from the scope of the present disclosure.

Referring again to FIG. 1, in one particular implementation, the sealing members 72 (also sealing members 72′, 72″, 72A, 72B, 72C, 72D, 72E) may be present in the wall structure 30 (FIG. 2) at a pre-determined and fixed height H (e.g., a constant waterline above the tarmac 22). Therefore, regardless of the longitudinal position along the longitudinal axis X, the height H of the sealing members 72 may be constant, thereby enabling maintenance crews to quickly locate and access the sealing members 72 should the need arise.

Various benefits may be achieved by incorporating the disclosed sealing members 72′, 72″, 72A, 72B, 72C, 72D, 72E into the wall volume 70 of the wall structure 30 to reduce (if not eliminate) sidewall air flow. For example, cabin ventilation effectiveness may be improved; ground cabin heat load may be reduced; the potential for cargo or EE bay smoke penetration into the passenger cabin may be reduced; cabin humidity may be improved by reducing condensation; and condensation on structure and other material in the wall structure 30 (and associated effects) may be reduced.

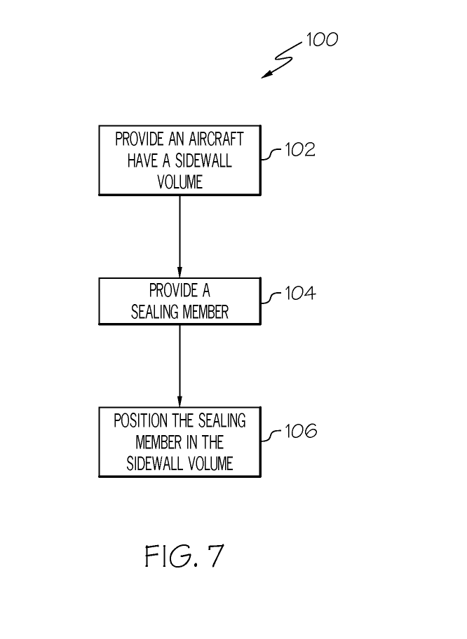

Referring to FIG. 7, also disclosed is a method 100 for reducing air flow. The method 100 may be performed during the original manufacture of aircraft, as well as during repair, maintenance and/or retrofitting.

The method 100 may begin at Block 102 with the step of providing an aircraft. The aircraft may include a fuselage having a wall structure that includes an outboard boundary spaced apart from an inboard boundary to define a wall volume therebetween. Various wall volume components, such as insulation, fire barriers, transport elements and the like, may be housed in the wall volume.

At Block 104, a sealing member (or multiple sealing members) may be provided for the starboard side of the aircraft and a sealing member (or multiple sealing members) may be provided for the port side of the aircraft. The sealing member may be formed from a flexible yet resilient material, such as an elastomeric material. Optionally, one or more through-channels may be formed in the sealing member to accommodate one or more of the wall volume components housed in the wall volume.

At Block 106, the sealing members may be positioned in the wall volume to reduce, if not eliminate, undesired air flow within the wall volume. The sealing members may be positioned such that they extend axially along at least a portion of the length of the fuselage at a substantially constant height (relative to the tarmac). In one embodiment, the sealing members may span the entire gap between the outboard boundary and the inboard boundary. In another embodiment, the sealing members may span over only a portion (or several portions) of the gap between the outboard boundary and the inboard boundary.

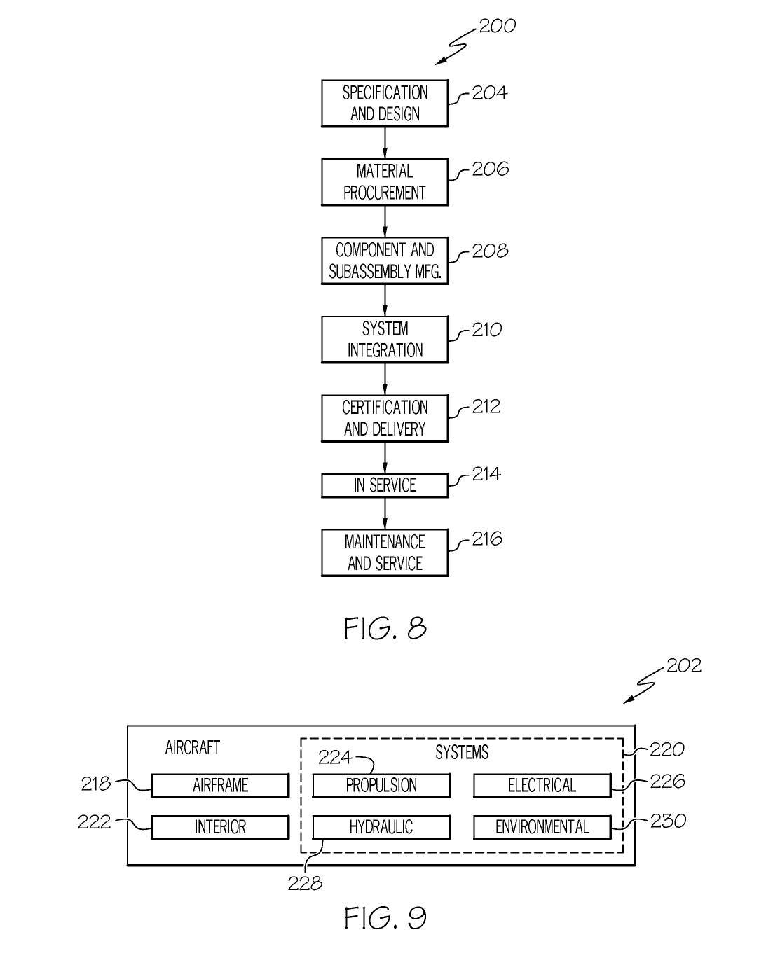

Examples of the disclosure may be described in the context of an aircraft manufacturing and service method 200, as shown in FIG. 8, and an aircraft 202, as shown in FIG. 9. During pre-production, the aircraft manufacturing and service method 200 may include specification and design 204 of the aircraft 202 and material procurement 206. During production, component/subassembly manufacturing 208 and system integration 210 of the aircraft 202 takes place. Thereafter, the aircraft 202 may go through certification and delivery 212 in order to be placed in service 214. While in service by a customer, the aircraft 202 is scheduled for routine maintenance and service 216, which may also include modification, reconfiguration, refurbishment and the like.

Each of the processes of method 200 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 9, the aircraft 202 produced by example method 200 may include an airframe 218 with a plurality of systems 220 and an interior 222. Examples of the plurality of systems 220 may include one or more of a propulsion system 224, an electrical system 226, a hydraulic system 228, and an environmental system 230. Any number of other systems may be included. Although an aerospace example is shown, the principles of the disclosed aircraft 10 and method 100 may be applied to other industries, such as the automotive industry.

Apparatus and methods embodied herein may be employed during any one or more of the stages of the production and service method 200. For example, components or subassemblies corresponding to component/subassembly manufacturing 208, system integration 210, and or maintenance and service 216 may be fabricated or manufactured using the disclosed sealing member. Also, one or more apparatus examples, method examples, or a combination thereof may be utilized during component/subassembly manufacturing 208 and/or system integration 210, for example, by substantially expediting assembly of or reducing the cost of an aircraft 202, such as the airframe 218 and/or the interior 222. Similarly, one or more of apparatus examples, method examples, or a combination thereof may be utilized while the aircraft 202 is in service, for example and without limitation, to maintenance and service 216.

Although various embodiments of the disclosed structure and method for reducing air flow in a wall volume of an aircraft have been shown and described, modifications may occur to those skilled in the art upon reading the specification. The present application includes such modifications and is limited only by the scope of the claims.

What is claimed is:

1. An aircraft comprising:
a fuselage defining an upper lobe and a lower lobe, said fuselage comprising a wall structure that comprises:
an outboard boundary; and
an inboard boundary spaced from said outboard boundary,
wherein said outboard boundary and said inboard boundary define a wall volume therebetween; and
at least one sealing member positioned in said wall volume.

2. The aircraft of claim 1 wherein said upper lobe is separated from said lower lobe by a floor beam.

3. The aircraft of claim 1 wherein said outboard boundary comprises a skin of said fuselage.

4. The aircraft of claim 3 wherein said upper lobe comprises a passenger cabin comprising a passenger cabin sidewall, and wherein said passenger cabin sidewall comprises at least a portion of said inboard boundary.

5. The aircraft of claim 1 wherein said outboard boundary comprises an aft pressure bulkhead.

6. The aircraft of claim 5 wherein said inboard boundary comprises a passenger cabin sidewall.

7. The aircraft of claim 5 wherein said inboard boundary comprises an aft cabin galley endwall.

8. The aircraft of claim 1 further comprising at least one of an insulation, a fire barrier and a transport element positioned in said wall volume.

9. The aircraft of claim 1 further comprising a transport element positioned in said wall volume, wherein said transport element extends through said sealing member.

10. The aircraft of claim 1 wherein said fuselage has a longitudinal length, and wherein said sealing member longitudinally extends through said wall volume along at least a portion of said longitudinal length.

11. The aircraft of claim 10 wherein said sealing member has a sealing member total longitudinal length that is at least about 20 percent of said longitudinal length of said fuselage.

12. The aircraft of claim 11 wherein said sealing member total longitudinal length is comprised of segments.

13. The aircraft of claim 10 wherein said sealing member has a sealing member total longitudinal length that is at least about 50 percent of said longitudinal length of said fuselage.

14. The aircraft of claim 1 wherein said sealing member longitudinally extends through said wall volume along a substantially constant waterline.

15. The aircraft of claim 1 wherein said fuselage comprises a return air grille, and wherein said sealing member is positioned proximate said return air grille.

16. The aircraft of claim 1 wherein said sealing member comprises an elastomeric material.

17. The aircraft of claim 1 wherein said sealing member comprises at least one of a bulb seal and a blade seal.

18. The aircraft of claim 1 comprising a plurality of sealing members positioned between said outboard boundary and said inboard boundary.

19. The aircraft of claim 18 further comprising a plurality of wall volume components positioned in said wall volume, wherein at least one sealing member of said plurality of sealing members is positioned between adjacent wall volume components of said plurality of wall volume components.

20. A method for reducing air flow in an aircraft comprising steps of:
providing at least one sealing member in a wall volume between an outboard boundary and an inboard boundary of a wall structure that extends along a longitudinal axis of said aircraft, said sealing member positioned in said wall volume such that said sealing member axially extends through said wall volume at a substantially constant waterline.
